(19) United States
(12) Patent Application Publication
(10) Pub. No.: US 2026/0065328 A1
(43) Pub. Date: Mar. 5, 2026

(54) NEXUS SHOPPER CLOUD-BASED SOFTWARE PLATFORM

(71) Applicant: The Additive LLC, Manhattan Beach, CA (US)

(72) Inventor: RYAN TURNER, Manhattan Beach, CA (US)

(21) Appl. No.: 19/306,864

(22) Filed: Aug. 21, 2025

Related U.S. Application Data
(60) Provisional application No. 63/690,792, filed on Sep. 4, 2024.

(51) Int. Cl. G06Q 30/0241

(52) U.S. Cl. CPC G06Q 30/0276

(57) ABSTRACT

A method of creating a promotional video may include uploading product image files and corresponding metadata; standardizing product image files and corresponding metadata into standardized image files; storing the standardized image files and the corresponding metadata into a product database, wherein the corresponding metadata includes name, description, size or price of the selected product; receiving product selection from a user and retrieving a standardized image file and corresponding metadata from the product database; receiving promotional parameters and promotional start (flight) date for the received product selection and store the received promotional parameters and the received start date with associated standardized image files and the corresponding metadata for the received product selection; and rendering a selected product promotional video for the received product selection based at least in part of the product selection standardized image file and corresponding metadata.

### RELATED APPLICATIONS

This application claims priority to U.S. provisional patent application Ser. No. 63/690,792, filed Sep. 4, 2024, entitled “Nexus Shopper Cloud-Based Software Platform,” the entirety of which is hereby incorporated by reference.

### BACKGROUND

It is important for retailers to have in-store and online digital marketing for the products that are in their brick and mortar stores or are being sold on their online marketplaces. Large retail operations are able to cost justify having digital marketing departments that can create and/or distribute digital advertisements to monitors or displays within a retail establishment, to social media channels or to a retailer's online marketplace. In addition, the promotions change weekly (and sometimes daily), and thus it is difficult to keep the digital advertisements up to date. It is impossible for smaller retailers (e.g., grocery stores, hardware stores) to create digital advertisements (e.g., promotional videos) at a sufficient rate since the ads need to be changed frequently and many need to be created. Further, it is too cost prohibitive and requires a massive time constraint for smaller, independent and regional stores (in the grocery, retail and hardware markets) to create relevant video advertisements for in-store, connected TV (“CTV”) or social media platforms.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates a flowchart of operation of the Nexus Shopper cloud-based software platform, in accordance with some embodiments;

FIG. 2 illustrates a product image file, in accordance with some embodiments;

FIG. 3A and FIG. 3B illustrates screen shots of portions of select product promotional videos, in accordance with some embodiments;

FIG. 3C illustrates screen shots of a frame of a product promotional video, in accordance with some embodiments; and

FIG. 4 illustrates a block diagram of the NEXUS SHOPPER cloud-based software platform in accordance with exemplary embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

A cloud-based software platform allows managers or owners of smaller retail establishments to submit image files, associated metadata, and/or promotional parameters to the software platform in order to have digital advertisements (e.g., digital product promotion videos) automatically generated and/or automatically distributed to selected display devices that are located in retail stores and/or commercial stores. This provides managers or owners with increased efficiency in creating, generating and distributing digital advertisements. In exemplary embodiments, the NEXUS SHOPPER cloud-based software platform may utilize uploaded product images and product metadata multiple times once the product image and/or product metadata is approved and standardized by the cloud-based software platform (meaning that the manager or owner had submitted the product images file early). The cloud-based software platform (e.g., NEXUS SHOPPER) may manage generation of digital product promotion videos by modifying and changing the input image and adding relevant meta-data into the generated promotional video file. In other words, the subject matter described herein is not just transferring data; it is creating a new generated promotional video file. This improves the processing time in the NS cloud-based computer devices due to this new and unique file. In addition, the NEXUS SHOPPER (NS) cloud-based software platform may store the created digital product promotional videos in a customized database. Further, the NEXUS SHOPPER cloud-based software platform may distribute the digital product promotional videos to in-store displays, social media platforms and/or to retail store online marketplaces. The NEXUS SHOPPER cloud-based software platform may be referred to as a retail or commerce cloud-based promotional video creation and distribution software platform.

In exemplary embodiments, the NEXUS SHOPPER cloud-based software platform may be computer-readable instructions stored in one or multiple cloud-based computing devices and/or servers and/or executable by one or more processors or controllers in the cloud-based computing devices and/or servers to operate the NEXUS SHOPPER system for users or retail store owners. In other words, there may be one or more cloud-based computing devices that have the NS cloud-based software platform installed thereon and/or executing the computer-readable instructions stored thereon. In exemplary embodiments, a user or retail store owner may login to their account on the NEXUS SHOPPER cloud-based software platform and manage the creation and/or distribution of the digital product promotional videos in their different retail and store locations as described above or below.

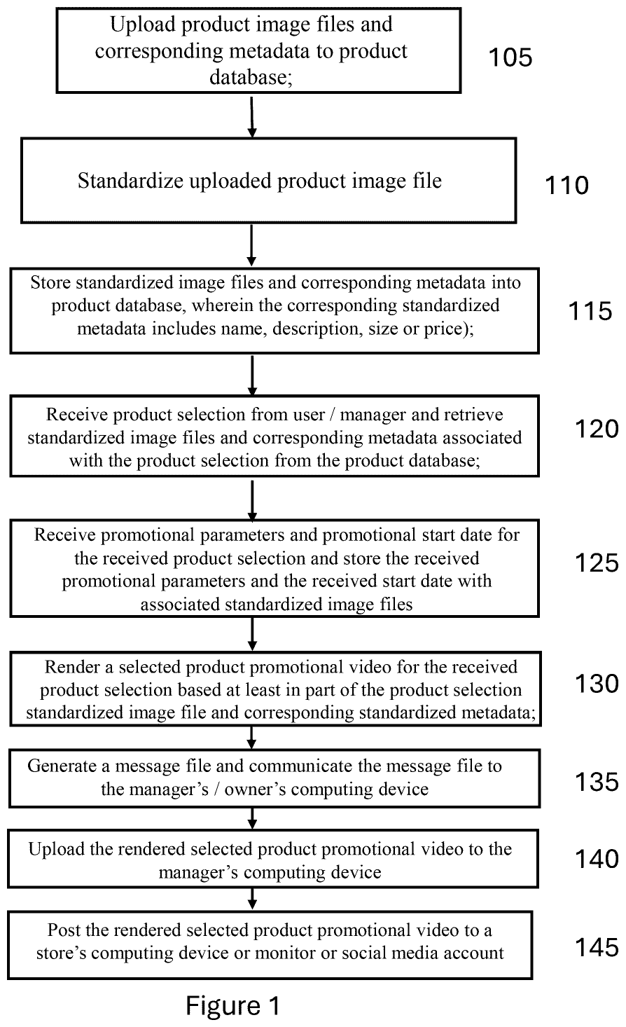

FIG. 1 illustrates a flowchart of operation of the NEXUS SHOPPER cloud-based software platform according to exemplary embodiments.

In exemplary embodiments, in step 105, a user, manager or retail store owner may upload one or more product image files and associated or corresponding metadata to a product database. In exemplary embodiments, the product database may be located on a cloud-based computing device (e.g., the one or more computing devices including the NEXUS SHOPPER (“NS”) cloud-based software platform). In exemplary embodiments, the product image file may be a .jpeg, .jpg, .tiff, or .png file. In other embodiments, other image file formats may be utilized.

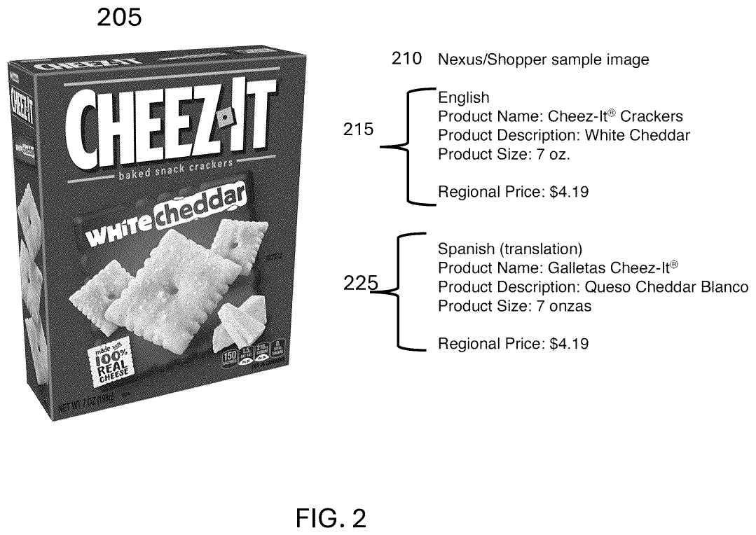

In exemplary embodiments, in step 110, the NS cloud-based software platform may convert or standardize the uploaded or received product image files into a standard image file format. In other words, the received image file format may be changed. In some embodiments, that may be the .png file format. In exemplary embodiments, the NS cloud-based software platform may resize the image and may strip or remove background or other images from the uploaded image. In other words, the image file format may be changed as well as the content of the image may be modified or changed. In exemplary embodiments, the resizing and/or stripping or removal of background images may occur automatically. In exemplary embodiments, the NS cloud-based software platform may automatically extract the associated or corresponding metadata from the uploaded image file. FIG. 2 illustrates an example product image file in accordance with exemplary embodiments. In exemplary embodiments, the uploaded file may include a product image 205 (e.g., the Cheez-It product image) along with an image name 210 and product metadata 215. In FIG. 2, the product metadata 215 may include a language of the image, a product name, a product description or feature, a product size and/or a regular price of the product. FIG. 2 also includes foreign language product metadata for the selected product. In FIG. 2, foreign language metadata 225 (in Spanish) may also be received and/or generated by the NEXUS SHOPPER cloud-based software platform and may then be utilized in the generated or rendered product promotional video. In exemplary embodiments, the product metadata may also be received in a separate file or input by the user or owner.

In exemplary embodiments, in step 115, the NS cloud-based software platform may store the standardized product image file and the received product metadata in a product database of the NS cloud-based software platform. In exemplary embodiments, the storing of the standardized product image file and metadata may occur automatically. In exemplary embodiments, the product meta data may include product brand, product name, product description, product price per unit, product size and/or legal information. In addition, in exemplary embodiments, the product metadata may include the product brand logo. Further, in other embodiments, the product metadata may also include product benefits, product selling points, product tag lines and/or product uses. In exemplary embodiments, store brands or generic product images may also be stored in the NS database. In some embodiments, the storing may occur automatically. As illustrative examples, the store brands (and/or associated images) may include eggs, milk, product, meat, seafood, bakery, eggs and/or flowers. Information or metadata for these products may also be stored in the NS database. In exemplary embodiments, the NEXUS SHOPPER cloud-based software platform may utilize uploaded product images and product metadata multiple times once the product image and/or product metadata is approved and standardized by the cloud-based software platform. As illustrative examples, if a retail store named Shop N Save uploads an image of a Pepsi Cola 12-pack and associated product meta data (e.g., name=Pepsi Cola Zero Sugar; quantity=12 cans; volume=12 ounces, and a product logo) to the NEXUS SHOPPER cloud-based software platform, once the product image and the associated product metadata is standardized and/or approved by the Nexus Shopper cloud-based software platform, then other retail stores (e.g., Smart N Final, Family Dollar, Wegmans, or Kroger) may utilize the standardized product image and product metadata (or in some cases only the standardized product image and part of the product metadata (e.g., a different price, for example, may be utilized by different stores). In exemplary embodiments, the manager or owner may log into the NEXUS SHOPPER cloud-based software platform and select these pre-existing product images and product metadata. In other embodiments, where the product image and product metadata are for store brands (e.g., Costco Kirkland brand or Smart and Final First Street brand), these product images and product metadata may only be seen and used by the owner of the brand. In other words, these database records (e.g., the Costco Kirkland brand) may only be accessible or viewable by Costco personnel (e.g., managers or owners) utilizing the NEXUS SHOPPER cloud-based software platform.

In exemplary embodiments, the NEXUS SHOPPER cloud-based software platform may receive product metadata in additional languages such as Spanish, German, Chinese and/or Japanese. In some embodiments, the NEXUS SHOPPER cloud-based software platform may only receive the product metadata in one language, and may generate product metadata in multiple languages in order to utilize the product metadata in other languages in product promotional videos that utilize the other language. In exemplary embodiments, the NEXUS SHOPPER software platform may automatically convert product metadata into one or more additional languages. In exemplary embodiments, these foreign or other language product promotional videos may be transmitted to markets where a population is primarily foreign language markets (e.g., the population may be primarily Chinese or Spanish speaking). This is another novel, unique and/or useful feature of the NEXUS SHOPPER cloud-based software platform.

In exemplary embodiments, the process outlined in steps 105, 110, and/or 115 may be repeated for all products that the user, manager or store owner may desire to have promotional product videos generated for. In exemplary embodiments, the NS cloud-based software may perform the converting and/or standardizing of the image files and/or the storing of the standardized product images files and/or product metadata automatically after receiving the product image file and/or associated product metadata.

Every week, a retail store manager or owner may have weekly (or longer) offers, deals and/or discounts that they would like to promote to potential customers. In some embodiments, the length of the promotion may be longer than one week. The length of the promotion may be referred to as a flight time. In some embodiments, the flight time may vary by store, by location and/or by brand.

In exemplary embodiments, in step 120, the retail store manager or owner may login into the NS cloud-based software platform and may enter one or more product selections. In exemplary embodiments, the NS cloud-based software platform may receive the one or more product selections and may automatically retrieve the standardized product image and/or associated metadata corresponding to the selected one or more product selections from the product database.

In exemplary embodiments, in step 125, the retail storage manager or owner may enter in promotion parameters and/or promotional start date parameters for a selected timeframe. In exemplary embodiments, the promotional parameters may be a flight time or a promotion length. In exemplary embodiments, the promotional parameters may also include a promotional video length (e.g., how long is the product promotional video) and/or if another product promotional video is going to be played along with the selected promotional video. In some embodiments, the promotional parameters may be limited to only the promotion start date and/or the flight time or promotion length. In other embodiments, the promotional parameters may include background video parameters (color or other images), video effect parameters (e.g., including dripping water, a mist, or fire in one of the product promotional videos, how multiple product promotional videos may be stitched or transitioned together) and placement parameters (e.g., location of price, image, and/or other product metadata in the product promotional videos—is the product image displayed on top of the price, location of the product price, location of other metadata with respect to the product price and/or the product image.) In exemplary embodiments, once the manager or owner enters the promotional parameters with the associated selected product image and/or selected product metadata, the NEXUS shopper cloud-based software platform may generate a real-time preview of the promotional video for approval by the manager or owner (e.g., referred to as a preview promotional video). In exemplary embodiments, the preview promotion video is a newly created video file where the video file incorporates all of the product metadata, video effect parameters, video parameters and/or placement parameters. In these exemplary embodiments, after viewing the preview promotional video, the user or manager may enter additional promotional parameters and/or call-to-action (CTA) parameters, such as “On Sale Now,” “Best Price of the Year,” or 50% off, and these additional promotional parameters or CTA parameters may be added to the preview promotional video (and later the generated or rendered product promotional video (described in detail below). In other words, the rendered production promotion video may be a new video file also including additional promotional parameters and/or CTA parameters.

In exemplary embodiments, in step 130, the NS cloud-based software platform may render a selected product promotional video based at least in part on the selected product, the standardized product image, the product metadata and/or the promotional parameters. In exemplary embodiments, the selected or rendered product promotional video may be 10 seconds, 20 seconds, 30 seconds or another timeframe in length. In exemplary embodiments, the rendered product promotional video may include multiple products. In exemplary embodiments, the rendered product promotional video may include two background images and a transition between the two background images for the selected product (or product). In exemplary embodiments, the rendered product promotional video may include video effects such as water droplets or running water or smoke in the background. In exemplary embodiments, the rendered product promotional video may include different placement for various metadata. In exemplary embodiments, the rendered product promotional video may have a resolution of any size (e.g., 1920×1080 pixels or 1080×1080 pixels). In exemplary embodiments, the rendered product promotional video may have different aspect ratios and different display formats (e.g., vertical, horizontal, square, etc.). In exemplary embodiments, the size, resolution, aspect ratio and/or format of the product promotional video may be additional promotional parameters. In exemplary embodiments, the rendered product promotional video may also have live action video of the promoted product (which may have to be uploaded to the NEXUS SHOPPER cloud-based software platform). In exemplary embodiments, the rendered product promotional video may include a theme (e.g., another promotional parameter), which may be based on an upcoming or currently happening live event (e.g., a sporting event, a holiday, weather,) or a local area team or group of interest like a sports team). As an illustrative example, the product promotional video may be a video for Doritos which may include a promotional deal for an upcoming National Football League game. This Doritos product promotional video may include a promotional offer price, a football themed look, live or recorded footage of a football and even a logo of the NFL team (if image is properly licensed). In exemplary embodiments, the NEXUS SHOPPER cloud-based software platform may generate a plurality of product promotional videos for a selected product, where each of the plurality of product promotional videos includes text or graphics in a different language from English. In other words, the NEXUS SHOPPER cloud-based software platform may utilize the different language metadata (e.g., German metadata or Japanese metadata) in order to generate and render the product promotional vehicle utilizing the selected foreign language.

In exemplary embodiments, in step 135, the NS cloud-based software platform may generate a message file and may communicate the generated message file to the manager or owner's computing device identifying that the product promotional video for the selected product(s) is/are ready.

In exemplary embodiments, in step 140, the NS cloud-based software platform may upload and/or transfer the rendered product promotional video to the manager or owner's computing device or to the retail or commercial computing device. In exemplary embodiments, the rendered product promotional video or product promotional video may include timing information (how long the video is and when transitions are in the product promotional video). In exemplary embodiments, once a product promotional video is generated or rendered, the product promotional video is stored in a database of the NEXUS SHOPPER cloud-based software platform. In exemplary embodiments, product promotional video creation parameters may also be stored in the database. In exemplary embodiments, the product promotional video creation parameters may be who or what entity created the product promotional video, what type of video (e.g., size, or aspect ratio), a length of the product promotional video and a date of creation and/or delivery of the product promotional video. In exemplary embodiments, the retail or commercial computing device or servers may include information on how often the product promotional video was played and/or results or analytics associated with the product promotional video. In exemplary embodiments, the retail or commercial computing device or servers may communicate this information as either analytics parameters and/or feedback parameters to the NEXUS SHOPPER cloud-based software platform.

In exemplary embodiments, in step 145, the NS cloud-based software program may post or communicate the rendered product promotional video to the retail or commercial store's computing device, display device(s) and/or social media account (located on the social media provider's computing device or a third party computing device).

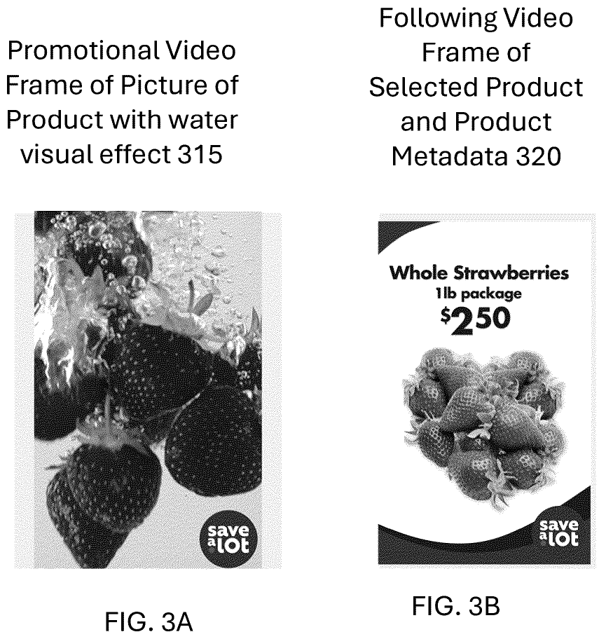

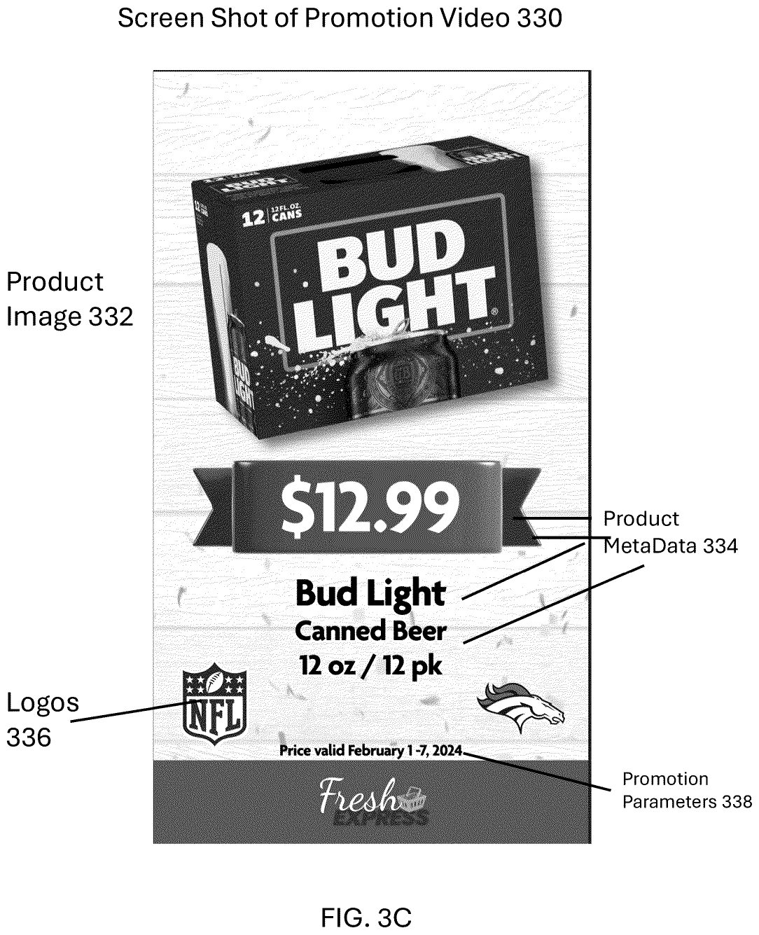

FIGS. 3A and 3B illustrate frames of product promotional videos according to exemplary embodiments. As discussed above, a product promotional video may include a plurality of images for a selected product. FIGS. 3A and 3B illustrate two frames of a product promotional video or video file that includes two original product images according to exemplary embodiments. The selected product in the FIGS. 3A and 3B product promotional videos are strawberries. In FIG. 3A, the frame 315 of the selected product promotional video includes an image of strawberries from the database of the NEXUS SHOPPER cloud-based software platform and also includes a water splashing effect in the video along with a promotional message of “Save a Lot.” In FIG. 3B, the frame 320 may include a different image of strawberries from the database of the NEXUS SHOPPER cloud-based software platform. In exemplary embodiments, the frame 320 may also include selected product metadata (e.g., a name of the selected product, a size or weight of the selected product and/or a price of the selected product) along with the same promotional message as frame 315 (FIG. 3A).

FIG. 3C illustrates screen shots of a frame of a product promotional video, in accordance with some embodiments. In exemplary embodiments, a frame 330 of the product promotional video may include a product image 332, product metadata 334, the promoter (e.g., Fresh Express), product promotional parameters 338, and/or logos (which may represent the theme (e.g., an NFL game involving the Broncos) 336. The logo 336 may be utilized to show what the product promotional video may be related to and/or in some cases may be additional sponsors of the product promotional video.

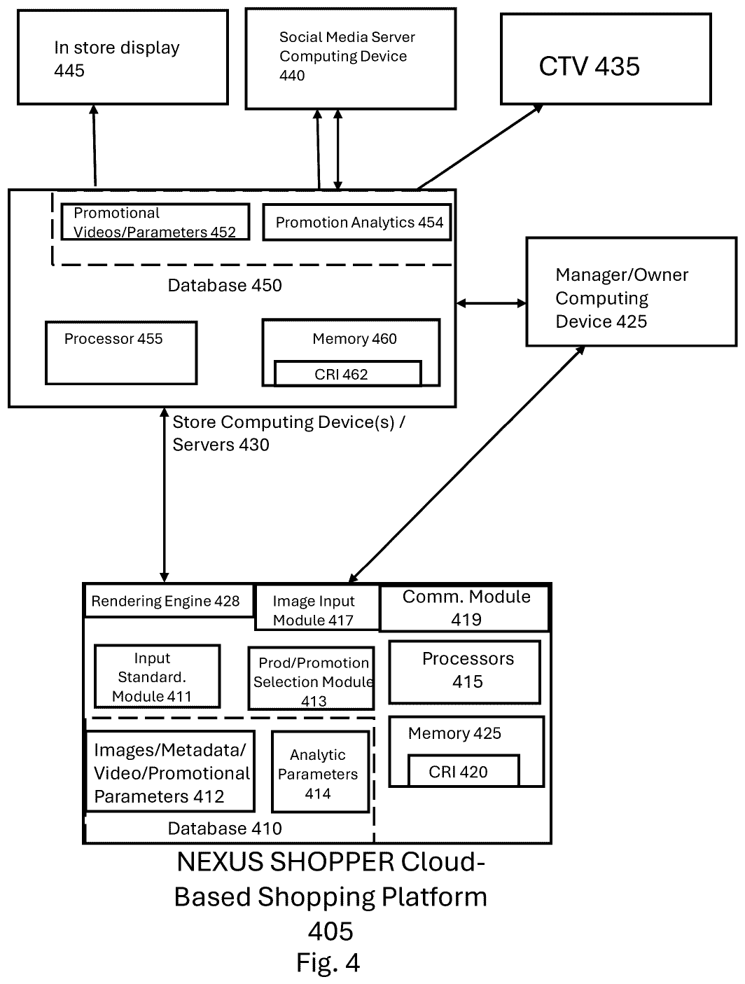

FIG. 4 illustrates a block diagram of the NEXUS SHOPPER cloud-based software platform system according to exemplary embodiments. In exemplary embodiments, the NEXUS SHOPPER cloud-based software platform system may include a NEXUS SHOPPER cloud-based software platform 405, one or more store computing devices or servers 430, a manager or owner computing device 425, one or more in-store displays 445, one or more social media server computing devices 440 and/or one or more connected television (CTV) devices 435. In exemplary embodiments, the NEXUS SHOPPER cloud-based software platform 405 may include a product database 410, one or more processors 415, a rendering engine or module 428, an image input module 417, an image standardization module 411, a product and promotion selection module 413, a communication module 419, one or more memory devices 425 and/or computer-readable instructions 420. In exemplary embodiments, the product database 410 may include storage for product images, product metadata and/or promotional parameters 412 and/or analytic parameters 414 (which may be received from the store computing device or servers 430). In exemplary embodiments, the computer-readable instructions 420 stored in the one or more memory devices 425 may be executable by the one or more processors or controllers 415 in order to control operation of the NEXUS SHOPPER cloud-based software platform 405. In exemplary embodiments, an image input module 417 may receive one or more product image file(s) and/or associated or corresponding metadata. In exemplary embodiments, the image standardization module 411 may receive the one or more product image file(s) and/or metadata and create or generate the one or more standardized product image files(s) and/or metadata. In exemplary embodiments, a product and promotion module 413 may receive additional product metadata, promotional parameters, call-to-action parameters, video parameters, video effect parameters, transition parameters, and/or placement parameters and may provide this information to the rendering engine and/or module 428. In some embodiments, the product and promotion module 413 may extract or automatically extract the product metadata from the one or more product image file(s) or the one or more standardized product image file(s). In exemplary embodiments, a communication module 419 may generate a message file and communicate the message file to a manager or owner computing device 425; and upload the rendered product promotional video to the manager or owner computing device 425. In exemplary embodiments, the communication module 419 may post or transmit the rendered product promotional video to a commercial or retail store computing device 430 or a commercial or retail storage monitor 445 or CTV 435 or a commercial or retail store social media account 440.

In exemplary embodiments, the rendering engine or module 428 may utilize the one or more selected product images or image files, the associated product metadata and/or the associated promotional parameters to create and render the selected product promotional video. As discussed previously, multiple rendered product promotional videos may be stitched or combined together by the NEXUS SHOPPER cloud-based software platform 405 to create the rendered product promotion video or video files. This may occur utilizing the rendering engine 428. In exemplary embodiment, the analytic parameters module 414 may receive and store a number of times product promotional videos are shown, reaction from retail outlets and/or what types of devices and/or locations received the rendered and transmitted product promotional videos.

In exemplary embodiments, the manager or owner may interface and/or communicate, utilizing the manager/owner computing device 425, with the NEXUS SHOPPER cloud-based software platform 405 and also may provide the product images, product metadata and/or promotional parameters.

In exemplary embodiments, the retail or commercial store computing device servers 430 may communicate with both the manager owner computing device 425 and/or the NEXUS SHOPPER cloud-based software platform 405 via wireless or wired communication networks. In exemplary embodiments, the NEXUS SHOPPER cloud-based software platform 405 may communicate the rendered product promotional videos to the store computing device or servers 430. In exemplary embodiments, the NS cloud-based software platform 405 and/or the retail or commercial computing device servers or computing devices 425 may be on the same physical computing device or may be on separate physical computing device(s). In exemplary embodiments, the store computing device servers 430 may include one or more memory devices 460, one or more processors or controllers 455, computer-readable instructions 462, and/or a store database 450. In exemplary embodiments, the computer-readable instructions 462 may be retrieved from the one or more memory devices 460 and may be executable by the one or more processors 455 to control operation of the one or more store computing devices or servers 430. In exemplary embodiments, the store database 450 may include storage areas or modules 452 for the received rendered product promotional videos and/or any associated promotional parameters. In exemplary embodiments, the manager or owner may utilize the manager/owner computing device 425 to input transmission or playing parameters and/or times for the rendered product promotional videos to be transmitted or communicate (and thus displayed) and communicate these to the store computing device servers 430. In exemplary embodiments, the received transmission or playing parameter and/or times for the product promotional videos may be stored in the commercial or retail store database 450. In exemplary embodiments, the computer-readable instructions 462 may be executable by the one or more processors or controllers 455 to utilize the transmission or playing parameters and/or times and communicate the selected product promotional videos (along with the parameters or times) to the one or more display devices. In exemplary embodiments, the one or more display devices may be one or more in-store displays 445, one or more social media server computing devices 440 and/or one or more CTVs 435. In exemplary embodiments, the display devices may also communicate information back to the store computing device servers 430 that may be stored in the promotional analytics 454 of the store database. This may include number of times video was played and potential viewing parameters.

In exemplary embodiments, a method of creating a promotional video includes uploading product image files and corresponding metadata; standardizing product image files and corresponding metadata to generate standardized image files and corresponding metadata; storing the standardized image files and the corresponding metadata into a product database, wherein the corresponding metadata includes name, description, size or price of the product or products; receiving a product selection from a user and retrieve standardized image files and corresponding metadata associated with the product selection from the product database; receiving promotional parameters including promotional start or a flight date for the received product selection and store the received promotional parameters including the received start or flight date with the associated standardized image files and the corresponding metadata for the received product selection; rendering a product promotional video for the received product selection based at least in part of the associated standardized image files and the corresponding metadata; storing the rendered product promotional video in the product database; generating a message file and communicate the message file to a manager or owner computing device; uploading the rendered product promotional video to the manager or owner computing device; and posting the rendered product promotional video to a commercial or retail store computing device or the commercial or retail storage monitor or commercial or retail store social media account. In exemplary embodiments, the corresponding metadata includes product metadata in one or more other languages than English. In exemplary embodiments, the method includes generating additional product metadata in another language besides English.

In exemplary embodiments, the received promotional parameters include a promotional video length and a number of product image files to be included in the rendered product promotional video. In exemplary embodiments, the received promotional parameters include video background parameters, video effect parameters, and placement parameters. In exemplary embodiments, the method further includes generating a preview promotional video before generating the rendered product promotional video; communicating the preview promotional video to the manager or owner computing device; receiving additional promotional parameters and call-to-action parameters from the manager or owner computing device; and incorporating the additional promotional parameters and/or the call-to-action parameters into the rendered product promotional video. In exemplary embodiments, the rendered production promotional video includes multiple product image files. In exemplary embodiments, a method of creating a rendered promotional video includes uploading a product image file; extracting corresponding product metadata from the product image file; standardizing the product image file and the corresponding product metadata to generate a standardized image file and corresponding product metadata; storing the standardized image file and the corresponding product metadata into a product database, wherein the corresponding product metadata includes a name, a description, a size or a price of the product; receiving a product selection and retrieving the standardized image file and corresponding product metadata associated with the received product selection from the product database; receiving promotional parameters including promotional start or flight date for the received product selection and storing the received promotional parameters including the received start or flight date with the associated standardized image files and the corresponding metadata for the received product selection in the product database; rendering a product promotional video for the received product selection based at least in part of the associated standardized image file and the corresponding product metadata; storing the rendered product promotional video in the product database; generating a message file and communicating the message file to a manager or owner computing device; and uploading the rendered product promotional video to the manager or owner computing device. In exemplary embodiments, the method of creating the promotional video includes posting or transmitting the rendered product promotional video to a commercial or retail store computing device or the commercial or retail storage monitor or commercial or retail store social media account. In exemplary embodiments, the method includes generating analytic parameters associated with the rendered product promotional video, wherein the generated analytic parameters include how often the rendered product promotional video is posted or transmitted and transmitting the analytic parameters to a cloud computing device. In exemplary embodiments, the method of creating the promotional video includes generating promotional video creation parameters, the promotional video creation parameters including who created the rendered product promotional video, a size or an aspect ratio of the rendered product promotional video, a length of the rendered product promotional video, and a date of creation of the rendered product promotional video.

In exemplary embodiments, the method of generating the promotional video includes uploading one or more additional product image files; extracting corresponding product metadata from the one or more additional product image files; standardizing the one or more product image files and the corresponding product metadata to generate one or more additional standardized image files and corresponding product metadata; storing the one or more additional standardized image files and the corresponding product metadata into the product database; receiving one or more additional product selections and retrieve the one or more standardized image files and corresponding product metadata associated with the one or more additional product selections from the product database; receiving additional promotional parameters including promotional start or flight date for the one or more received product selections and store the received additional promotional parameters including the received start or flight date with the associated one or more additional standardized image files and the corresponding metadata for the received one or more additional product selections in the product database; and rendering a new product promotional video for the received product selection and the one or more additional product selections based at least in part of the additional standardized image files and the corresponding product metadata and the associated one or more additional standardized image files and the corresponding metadata. In exemplary embodiments, the corresponding product metadata includes product metadata in one or more other languages than English. In exemplary embodiments, the method including generating additional product metadata in another language besides English. In exemplary embodiments, the received promotional parameters include a promotional video length and a number of product image files to be included in the rendered product promotional video. In exemplary embodiments, the received promotional parameters include video background parameters, video effect parameters, and placement parameters.

In exemplary embodiments, a system to generate a product promotional video includes a video input module configured to upload one or more product image files; a product and promotion module configured to extract corresponding product metadata from the one or more product image files; an image standardization module configured to standardize the one or more product image files and the corresponding product metadata to generate one or more standardized image files and corresponding product metadata; one or more memory devices configured to store the one or more standardized image files and the corresponding product metadata into a product database, wherein the corresponding product metadata includes a name, a description, a size or a price of the product; the product and promotion module configured to receive one or more product selections and retrieve the one or more standardized image files and corresponding product metadata associated with the one or more product selections from the product database; and configured to receive promotional parameters including promotional start or flight date for the received one or more product selections and store the received promotional parameters including the received start or flight date with the one or more associated standardized image files and the corresponding metadata for the received one or more product selections; a rendering engine or module configured to render a product promotional video for the received one or more product selections based at least in part of the one or more associated standardized image files and the corresponding product metadata and configured to store the rendered product promotional video in the product database; and a communication module configured to: generate a message file and communicate the message file to a manager or owner computing device; and upload the rendered product promotional video to the manager or owner computing device. In exemplary embodiments, the communication module is configured to post or transmitting the rendered product promotional video to a commercial or retail store computing device or a commercial or retail storage monitor or a commercial or retail store social media account. In exemplary embodiments, the commercial or retail store computing device configured to generate analytic parameters associated with the rendered product promotional video, wherein the generated analytic parameters include how often the rendered product promotional video is posted or transmitted and transmitting the analytic parameters to a cloud computing device. In exemplary embodiments, the cloud-based server computing device configured or the commercial or retail computing device is configured to generate promotional video creation parameters, the promotional video creation parameters including who created the rendered product promotional video, a size or an aspect ratio of the rendered product promotional video, a length of the rendered product promotional video, and a date of creation of the rendered product promotional video.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A method of creating a promotional video, comprising:
uploading product image files and corresponding metadata;
standardizing product image files and corresponding metadata to generate standardized image files and corresponding metadata;
storing the standardized image files and the corresponding metadata into a product database, wherein the corresponding metadata includes name, description, size or price of the product or products;
receiving a product selection from a user and retrieve standardized image files and corresponding metadata associated with the product selection from the product database;
receiving promotional parameters including promotional start or a flight date for the received product selection and store the received promotional parameters including the received start or flight date with the associated standardized image files and the corresponding metadata for the received product selection;
rendering a product promotional video for the received product selection based at least in part of the associated standardized image files and the corresponding metadata;
storing the rendered product promotional video in the product database;
generating a message file and communicate the message file to a manager or owner computing device;
uploading the rendered product promotional video to the manager or owner computing device; and
posting the rendered product promotional video to a commercial or retail store computing device or the commercial or retail storage monitor or commercial or retail store social media account.

2. The method of creating a promotional video of claim 1, wherein the corresponding metadata includes product metadata in one or more other languages than English.

3. The method of creating the promotional video of claim 1, further comprising generating additional product metadata in another language besides English.

4. The method of creating the promotional video of claim 1, wherein the received promotional parameters include a promotional video length and a number of product image files to be included in the rendered product promotional video.

5. The method of creating the promotional video of claim 1, wherein the received promotional parameters include video background parameters, video effect parameters, and placement parameters.

6. The method of creating the promotional video of claim 1, further comprising;
generating a preview promotional video before generating the rendered product promotional video;
communicating the preview promotional video to the manager or owner computing device;
receiving additional promotional parameters and call-to-action parameters from the manager or owner computing device; and
incorporating the additional promotional parameters and/or the call-to-action parameters into the rendered product promotional video.

7. The method of creating the promotional video of claim 1, wherein the rendered production promotional video includes multiple product image files.

8. A method of creating a rendered promotional video, comprising:
uploading a product image file;
extracting corresponding product metadata from the product image file;
standardizing the product image file and the corresponding product metadata to generate a standardized image file and corresponding product metadata;
storing the standardized image file and the corresponding product metadata into a product database, wherein the corresponding product metadata includes a name, a description, a size or a price of the product;
receiving a product selection and retrieving the standardized image file and corresponding product metadata associated with the received product selection from the product database;
receiving promotional parameters including promotional start or flight date for the received product selection and storing the received promotional parameters including the received start or flight date with the associated standardized image files and the corresponding metadata for the received product selection in the product database;
rendering a product promotional video for the received product selection based at least in part of the associated standardized image file and the corresponding product metadata;
storing the rendered product promotional video in the product database;
generating a message file and communicating the message file to a manager or owner computing device; and
uploading the rendered product promotional video to the manager or owner computing device.

9. The method of claim 8, further comprising:
posting or transmitting the rendered product promotional video to a commercial or retail store computing device or the commercial or retail storage monitor or commercial or retail store social media account.

10. The method of claim 9, further comprising: generating analytic parameters associated with the rendered product promotional video, wherein the generated analytic parameters include how often the rendered product promotional video is posted or transmitted and transmitting the analytic parameters to a cloud computing device.

11. The method of claim 8, further including generating promotional video creation parameters, the promotional video creation parameters including who created the rendered product promotional video, a size or an aspect ratio of the rendered product promotional video, a length of the rendered product promotional video, and a date of creation of the rendered product promotional video.

12. The method of claim 8, further comprising: uploading one or more additional product image files;
extracting corresponding product metadata from the one or more additional product image files;
standardizing the one or more product image files and the corresponding product metadata to generate one or more additional standardized image files and corresponding product metadata;
storing the one or more additional standardized image files and the corresponding product metadata into the product database;
receiving one or more additional product selections and retrieve the one or more standardized image files and corresponding product metadata associated with the one or more additional product selections from the product database;
receiving additional promotional parameters including promotional start or flight date for the one or more received product selections and store the received additional promotional parameters including the received start or flight date with the associated one or more additional standardized image files and the corresponding metadata for the received one or more additional product selections in the product database; and
rendering a new product promotional video for the received product selection and the one or more additional product selections based at least in part of the additional standardized image files and the corresponding product metadata and the associated one or more additional standardized image files and the corresponding metadata.

13. The method of creating a promotional video of claim 8, wherein the corresponding product metadata includes product metadata in one or more other languages than English.

14. The method of creating the promotional video of claim 8, further comprising generating additional product metadata in another language besides English.

15. The method of creating the promotional video of claim 8, wherein the received promotional parameters include a promotional video length and a number of product image files to be included in the rendered product promotional video.

16. The method of creating the promotional video of claim 8, wherein the received promotional parameters include video background parameters, video effect parameters, and placement parameters.

17. A system to generate a product promotional video, comprising:
a video input module configured to upload one or more product image files;
a product and promotion module configured to extract corresponding product metadata from the one or more product image files;
an image standardization module configured to standardize the one or more product image files and the corresponding product metadata to generate one or more standardized image files and corresponding product metadata
one or more memory devices configured to store the one or more standardized image files and the corresponding product metadata into a product database, wherein the corresponding product metadata includes a name, a description, a size or a price of the product;
the product and promotion module configured to receive one or more product selections and retrieve the one or more standardized image files and corresponding product metadata associated with the one or more product selections from the product database; and configured to receive promotional parameters including promotional start or flight date for the received one or more product selections and store the received promotional parameters including the received start or flight date with the one or more associated standardized image files and the corresponding metadata for the received one or more product selections;
a rendering engine or module configured to render a product promotional video for the received one or more product selections based at least in part of the one or more associated standardized image files and the corresponding product metadata and configured to store the rendered product promotional video in the product database; and
a communication module configured to:
generate a message file and communicate the message file to a manager or owner computing device; and
upload the rendered product promotional video to the manager or owner computing device.

18. The system of claim 17, the communication module configured to post or transmitting the rendered product promotional video to a commercial or retail store computing device or a commercial or retail storage monitor or a commercial or retail store social media account.

19. The system of claim 18, the commercial or retail store computing device configured to generate analytic parameters associated with the rendered product promotional video, wherein the generated analytic parameters include how often the rendered product promotional video is posted or transmitted and transmitting the analytic parameters to a cloud computing device.

20. The system of claim 17, the cloud-based server computing device configured or the commercial or retail computing device configured to generate promotional video creation parameters, the promotional video creation parameters including who created the rendered product promotional video, a size or an aspect ratio of the rendered product promotional video, a length of the rendered product promotional video, and a date of creation of the rendered product promotional video.
